(19) United States
(12) Patent Application Publication
(10) Pub. No.: US 2008/0028785 A1
(43) Pub. Date: Feb. 7, 2008

(54) Refrigerator with see-through lid

(76) Inventor: Brian S. Kim, Rancho Palos Verdes, CA (US)

Correspondence Address: PARK LAW FIRM, 3255 WILSHIRE BLVD, SUITE 1110, LOS ANGELES, CA, 90010, US

(21) Appl. No.: 11/500,010

(22) Filed: Aug. 7, 2006

(51) Int. Cl. F25D 11/00; F17C 13/00; F25D 13/00

(52) U.S. Cl. 62/440; 62/458; 62/457.9

(57) ABSTRACT

A refrigerator includes a container that encloses a cooling space that is adapted to store food, a refrigerating circuit that lowers the temperature of cooling space, a moving support fixture that is adapted to move the refrigerator with small force, and a manual moving fixture that is adapted to move the refrigerator with manual force. The container includes an access device that allows access into the cooling space. The access device is at least partially transparent so that the inside of the cooling space is visible from outside the refrigerator. The access device is a door or lid, and is made of a transparent and thermally insulating material. The manual moving fixture includes a handle. The moving support fixture comprises a plurality of casters that are attached to the container.

### BACKGROUND OF THE INVENTION

The present invention relates to a refrigerator with see-through lid. More particularly, this invention relates to a refrigerator with see-through lid that also has portability and maneuverability.

See-through feature is very important in commercial applications of a food storage device such as a refrigerator or a freezer. Such feature is also helpful in home appliances. There are many examples of see-through lids or see-through doors in large scale and fixed refrigerator such as a walk-in refrigerator commonly used in grocery markets.

However, see-through feature has not been incorporated yet into a smaller and more diverse small-scale refrigerators or freezers. No effective combination of see-through feature with portability and easy handling has been provided by prior art.

Accordingly, a need for portable refrigerator with see-through door or lid has been present for a long time. This invention is directed to solve these problems and satisfy the long-felt need.

### SUMMARY OF THE INVENTION

The present invention contrives to solve the disadvantages of the prior art.

An object of the invention is to provide a refrigerator or freezer that has see-through lid or door.

Another object of the invention is to provide a refrigerator or freezer that combines portability with see through feature.

Still another object of the invention is to provide a refrigerator or freezer that is easy to handle or move.

In order to achieve the above objects, the present invention provides a refrigerator that includes a container that encloses a cooling space, which is adapted to store food, a refrigerating circuit that lowers the temperature of cooling space, and a support moving fixture that is adapted to move the refrigerator with small force.

The container includes an access device that allows access into the cooling space. The access device is at least partially transparent so that the inside of the cooling space is visible from outside the refrigerator.

The refrigerator may further include a manual moving fixture that is adapted to move the refrigerator with manual force. The manual moving fixture comprises a handle.

The container has a rectangular shape, and includes a front wall, two side walls, a rear wall, a top wall and a bottom wall.

In one embodiment, the handle includes one or more recesses that are provided on the side walls of the container. The recess has a depth and length that is adapted to receive fingers of a user.

In another embodiment, the handle includes one or more rods that are attached to the side walls of the container. The rod is spaced from the side wall with a predetermined interval.

The support moving fixture includes a plurality of casters that are attached to the container.

In one embodiment, the access device includes one or more doors that provide access into the cooling space through the front wall of the container. The door is a sliding door, or a hinged door.

In another embodiment, the access device includes one or more lids that provide access into the cooling space through the top wall of the container. The lid is a sliding lid, or a hinged lid.

The door or the lid is made of a transparent and thermally insulating material.

The refrigerator further includes a tray board that is provided on or near the top wall. The tray board is stored in a tray board recess on the sidewall with hooks when it is not used.

The advantages of the present invention are: (1) see-through feature is provided for small and various shape of refrigerators or freezers; (2) the refrigerators include self-contained refrigeration circuits and movable with casters; and (3) the refrigerators include handles that increase portability.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a refrigerator according to the present invention;

FIG. 2 is a schematic diagram showing the refrigerator;

FIG. 3 is a front elevation view of a refrigerator having hinged doors;

FIG. 4 is a front elevation view of a refrigerator having sliding doors;

FIG. 5 is a perspective view showing a refrigerator having sliding lids;

FIG. 6 is a perspective view showing a refrigerator having hinged lids;

FIG. 7 is a perspective view showing a refrigerator having a tray board; and

FIG. 8 is a perspective view showing that the tray board is stored on the sidewall.

### DETAILED DESCRIPTION OF THE INVENTION

FIGS. 1 and 2 show a refrigerator 10 according to the present invention. The refrigerator 10 includes a container 12 that encloses a cooling space 14, which is adapted to store food, a refrigerating circuit 16 that lowers the temperature of cooling space 14, and a support moving fixture 18 that is adapted to move the refrigerator 10 with small force. The refrigerating circuit 16 is adapted to constitute a self-contained system so that no plumbing is required, and portability is provided.

The container 12 includes an access device 20 that allows access into the cooling space 14. The access device 20 is at least partially transparent so that the inside of the cooling space 14 is visible from outside the refrigerator 10.

The refrigerator 10 further includes a manual moving fixture 22 that is adapted to move the refrigerator 10 with manual force. The manual moving fixture 22 includes a handle 24.

The container 12 has a rectangular shape, and includes a front wall 26, two side walls 28, a rear wall 30, a top wall 32 and a bottom wall 34.

In one embodiment shown in FIGS. 1, 3 and 4, the handle 24 includes one or more rods 38 that are attached to the side walls 28 of the container 12. The rod 38 is spaced from the side wall 28 with a predetermined interval, and fixed to the side wall 38 with brackets 40.

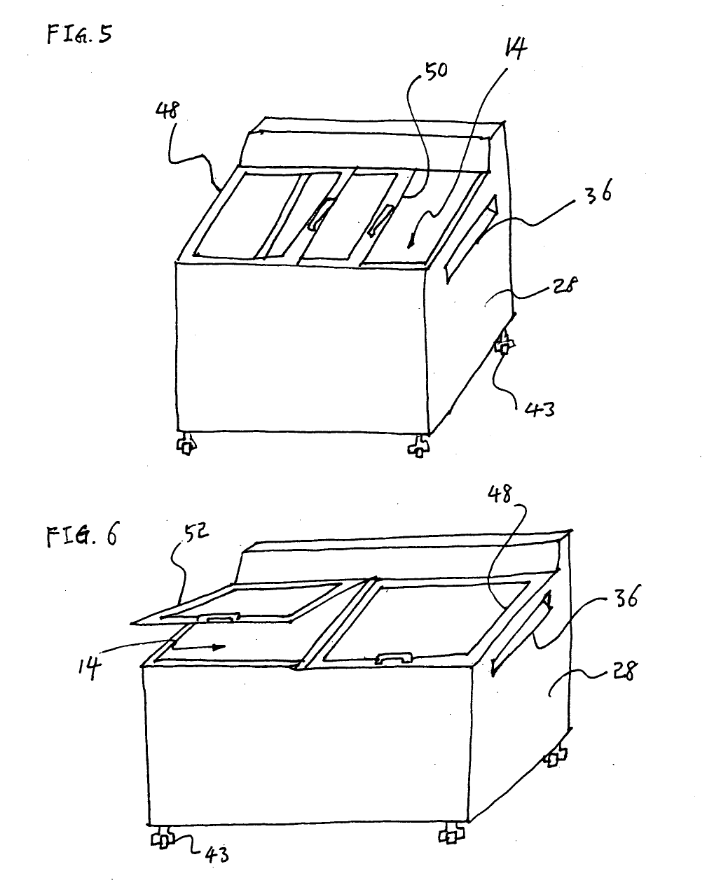

In another embodiment shown in FIGS. 5 and 6, the handle 24 includes one or more recess 36 that is provided on the side walls 28 of the container 12. The recess 36 has a depth and length that is adapted to receive fingers of a user.

The support moving fixture 18 includes a plurality of casters 43 that are attached to the bottom wall 34 of the container 12.

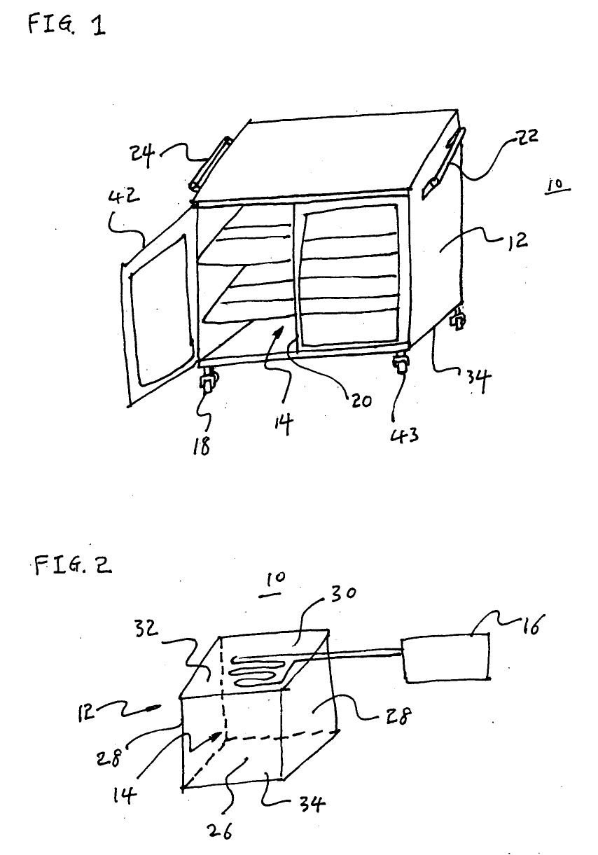

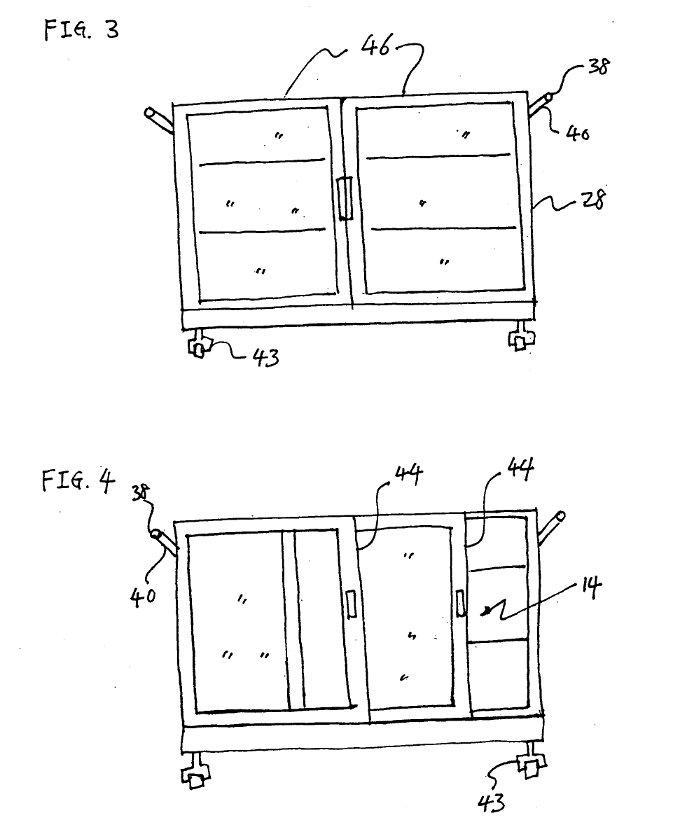

In one embodiment, the access device 20 includes one or more doors 42 that provide access into the cooling space 14 through the front wall 26 of the container 12. The door 42 is a sliding door 44 (refer to FIG. 4), or a hinged door 46 (refer to FIGS. 1 and 3).

In another embodiment, the access device 20 includes one or more lids 48 that provide access into the cooling space 14 through the top wall 32 of the container 12. The lid 48 is a sliding lid 50 (refer to FIG. 5), or a hinged lid 52 (refer to FIG. 6).

The door 42 or the lid 48 is made of a transparent and thermally insulating material.

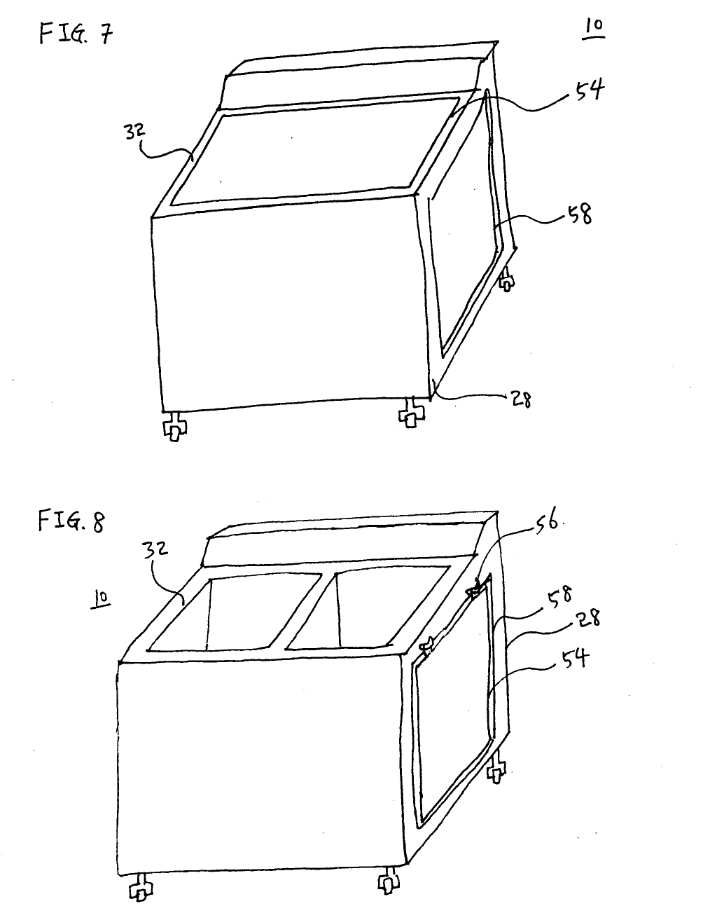

FIGS. 7 and 8 show that the refrigerator 10 may include a tray board 54, which is provided on or near the top wall 32. The tray board 54 may be stored in a tray board recess 58 on the sidewall 28 with one or more the hooks 56 when the tray board 54 is not used.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A refrigerator comprising:
a) a container that encloses a cooling space, wherein the cooling space is adapted to store food;
b) a refrigerating circuit that lowers the temperature of cooling space; and
c) a support moving fixture that is adapted to move the refrigerator with small force;
wherein the container comprises an access device that allows access into the cooling space, wherein the access device is at least partially transparent so that the inside of the cooling space is visible from outside the refrigerator, wherein the refrigerating circuit is self-contained.

2. The refrigerator of claim 1, further comprising a manual moving fixture that is adapted to move the refrigerator with manual force.

3. The refrigerator of claim 2, wherein the manual moving fixture comprises a handle.

4. The refrigerator of claim 3, wherein the container comprises a front wall, two side walls, and a rear wall, wherein the handle comprises one or more recesses that are provided on the side walls of the container.

5. The refrigerator of claim 4, wherein the recess has a depth and length that is adapted to receive fingers of a user.

6. The refrigerator of claim 3, wherein the container comprises a front wall, two side walls, and a rear wall, wherein the handle comprises one or more rods that are attached to the side walls of the container, wherein the rod is spaced from the side wall with a predetermined interval.

7. The refrigerator of claim 1, wherein the support moving fixture comprises a plurality of casters that are attached to the container.

8. The refrigerator of claim 1, wherein the container has a rectangular shape, and comprises a front wall, two side walls, a rear wall, a top wall and a bottom wall, wherein the access device comprises one or more doors that provide access into the cooling space through the front wall of the container.

9. The refrigerator of claim 8, wherein the door is a sliding door.

10. The refrigerator of claim 8, wherein the door is a hinged door.

11. The refrigerator of claim 8, wherein the door is made of a transparent and thermally insulating material.

12. The refrigerator of claim 11, further comprising a manual moving fixture that is adapted to move the refrigerator with manual force, wherein the manual moving fixture comprises a handle, wherein the support moving fixture comprises a plurality of casters that are attached to the container.

13. The refrigerator of claim 8, further comprising a tray board that is provided on or near the top wall, wherein the sidewall comprises a tray board recess and one or more hooks, wherein the tray board is stored in the tray board recess with the hooks.

14. The refrigerator of claim 1, wherein the container has a rectangular shape, and comprises a front wall, two side walls, a rear wall, a top wall and a bottom wall, wherein the access device comprises one or more lids that provide access into the cooling space through the top wall of the container.

15. The refrigerator of claim 14, wherein the access device further comprises one or more doors that provide access into the cooling space through the front wall of the container.

16. The refrigerator of claim 14, wherein the lid is a sliding lid.

17. The refrigerator of claim 14, wherein the lid is a hinged lid.

18. The refrigerator of claim 14, wherein the lid is made of a transparent and thermally insulating material.

19. The refrigerator of claim 18, further comprising a manual moving fixture that is adapted to move the refrigerator with manual force, wherein the manual moving fixture comprises a handle, wherein the support moving fixture comprises a plurality of casters that are attached to the container.

20. A refrigerator comprising:
a) a container that encloses a cooling space, wherein the cooling space is adapted to store food;
b) a refrigerating circuit that lowers the temperature of cooling space;
c) a support moving fixture that is adapted to move the refrigerator with small force;
d) a manual moving fixture that is adapted to move the refrigerator with manual force; and
e) a tray board that is provided on or near the top wall;
wherein the container comprises an access device that allows access into the cooling space, wherein the access device is at least partially transparent so that the inside of the cooling space is visible from outside the refrigerator, wherein the refrigerating circuit is self-contained, wherein the container comprises a front wall, two side walls, and a rear wall, wherein the sidewall comprises a tray board recess and one or more hooks, wherein the tray board is stored in the tray board recess with the hooks.
